(19) United States
(12) Patent Application Publication
(10) Pub. No.: US 2025/0150661 A1
(43) Pub. Date: May 8, 2025

(54) SYSTEM AND METHOD FOR STREAM RECOMMENDATION

(71) Applicant: 17LIVE Japan INC., Tokyo (JP)

(72) Inventors: Manasvi GHELANI, Tokyo (JP); Nitin SRIVASTAVEA, Tokyo (JP); Gayathri MANOHAR, Tokyo (JP); Anmol MOHAN, Tokyo (JP); Abinash SEN, Tokyo (JP); Gaurav TYAGI, Tokyo (JP)

(21) Appl. No.: 18/825,787

(22) Filed: Sep. 5, 2024

(30) Foreign Application Priority Data
Nov. 8, 2023 (JP) 2023-191156

(51) Int. Cl. H04N 21/258

(52) U.S. Cl. CPC H04N 21/258

(57) ABSTRACT

The present disclosure relates to a system and a method for stream distribution. The method includes: determining a first parameter of a distributor to be higher or lower than a first threshold; determining a first viewer to have a second parameter higher than a second threshold with respect to streams recommended to the first viewer; determining a second viewer to have a second parameter lower than the second threshold with respect to streams recommended to the second viewer; and recommending a stream of the distributor to the first viewer or the second viewer according to a result of the determining the first parameter to be higher or lower than the first threshold.

### CROSS-REFERENCE TO RELATED APPLICATIONS

This application is based on and claims the benefit of priority from Japanese Patent Application Serial No. 2023-191156 (filed on Nov. 8, 2023), the contents of which are hereby incorporated by reference in their entirety.

### BACKGROUND OF THE DISCLOSURE

### Technical Field

The present disclosure relates to stream recommendation and, more particularly, to live stream recommendation.

### Description of Related Art

Real time interaction on the Internet, such as live streaming service, has become popular in our daily life. There are various platforms or providers providing the service of live streaming, and the competition is fierce. It is important for a platform to provide its users their desired services.

Japanese patent application publication JP2019-164617A discloses a system for recommending live videos to users.

### SUMMARY OF THE DISCLOSURE

A method according to one embodiment of the present disclosure is a method for stream recommendation being executed by one or a plurality of computers, and includes: determining a first parameter of a distributor to be higher or lower than a first threshold; determining a first viewer to have a second parameter higher than a second threshold with respect to streams recommended to the first viewer; determining a second viewer to have a second parameter lower than the second threshold with respect to streams recommended to the second viewer; and recommending a stream of the distributor to the first viewer or the second viewer according to a result of the determining the first parameter to be higher or lower than the first threshold.

A system according to one embodiment of the present disclosure is a system for stream recommendation that includes one or a plurality of processors, and the one or plurality of processors execute a machine-readable instruction to perform: determining a first parameter of a distributor to be higher or lower than a first threshold; determining a first viewer to have a second parameter higher than a second threshold with respect to streams recommended to the first viewer; determining a second viewer to have a second parameter lower than the second threshold with respect to streams recommended to the second viewer; and recommending a stream of the distributor to the first viewer or the second viewer according to a result of the determining the first parameter to be higher or lower than the first threshold.

A non-transitory computer-readable medium including a program for stream recommendation, wherein the program causes one or a plurality of computers to execute: determining a first parameter of a distributor to be higher or lower than a first threshold; determining a first viewer to have a second parameter higher than a second threshold with respect to streams recommended to the first viewer; determining a second viewer to have a second parameter lower than the second threshold with respect to streams recommended to the second viewer; and recommending a stream of the distributor to the first viewer or the second viewer according to a result of the determining the first parameter to be higher or lower than the first threshold.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server 10 of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 is a data structure diagram showing an example of the distributor attractiveness score DB 330 of FIG. 3.

FIG. 8 is a data structure diagram showing an example of the viewer exploration score DB 332 of FIG. 3.

FIG. 9 is a data structure diagram showing an example of the stream position priority DB 334 of FIG. 3.

FIG. 10 is an example of a recommending page (or spotlight recommending section) on a user terminal of a viewer.

FIG. 11 shows an exemplary flowchart according to some embodiments of the present disclosure.

FIG. 12 shows an example of display position adjustment according to some embodiments of the present disclosure.

FIG. 13 is a block diagram showing an example of a hardware configuration of the information processing device according to some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

A distributor (or streamer) on a streaming platform would like to interact with as many viewers as possible to achieve higher rewards. How to expose different types of distributors to the right audience is important in encouraging the distributors and in improving the platform's operation.

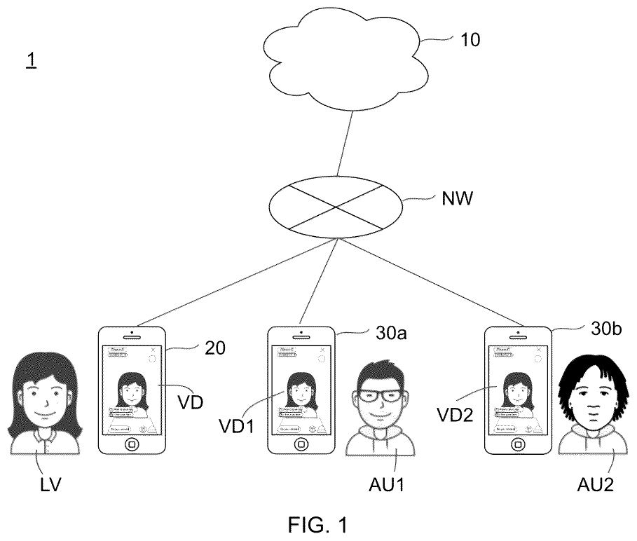

FIG. 1 shows a schematic configuration of a live streaming system 1 according to some embodiments of the present disclosure. The live streaming system 1 provides a live streaming service for the streaming streamer (could be referred to as liver, anchor, distributor, or livestreamer) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

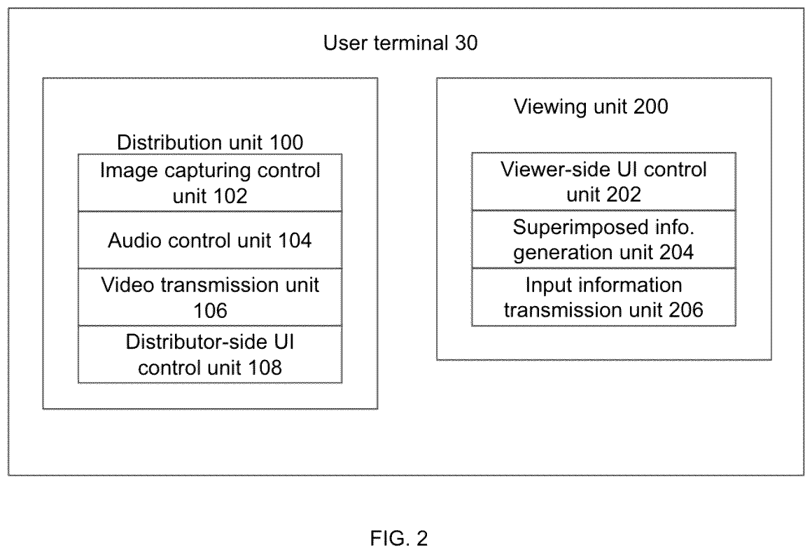

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distributor-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distributor-side UI control unit 108 controls an UI (user interface) for the distributor. The distributor-side UI control unit 108 may be connected to a display (not shown in FIG. 2), and displays a video on the display by reproducing the video data that is to be transmitted by the video transmission unit 106. The distributor-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

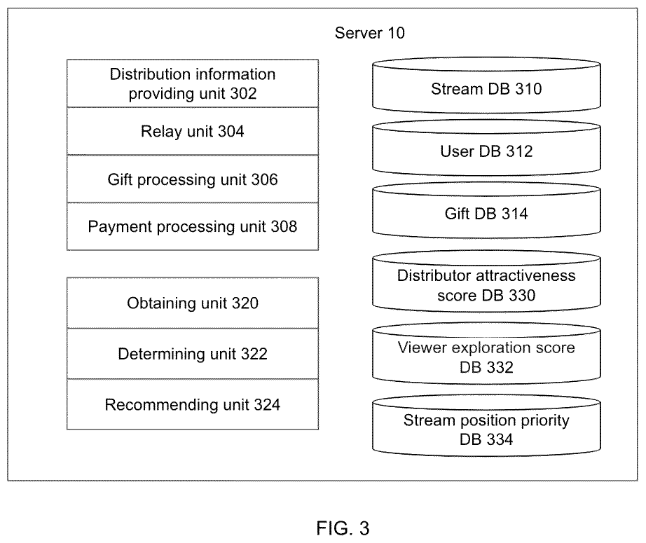

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, an obtaining unit 320, a determining unit 322, a recommending unit 324, a distributor attractiveness score DB 330, a viewer exploration score DB 332, and a stream position priority DB 334.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

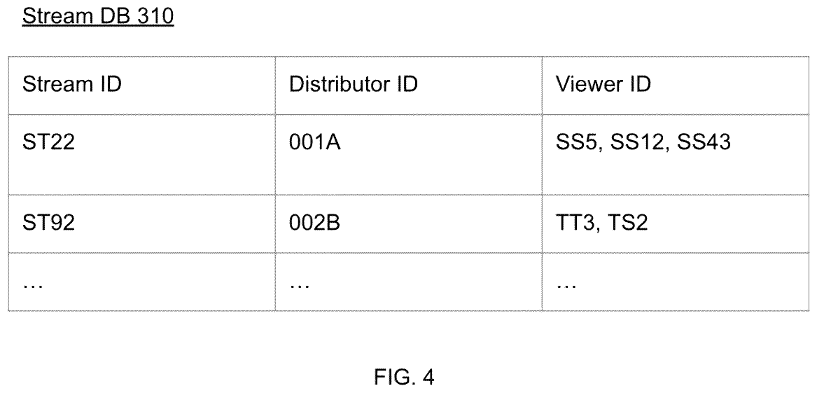

FIG. 4 is a data structure diagram of an example of the stream DB 310 of FIG. 3. The stream DB 310 holds information regarding a live stream currently taking place. The stream DB 310 stores the stream ID, the distributor ID, and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

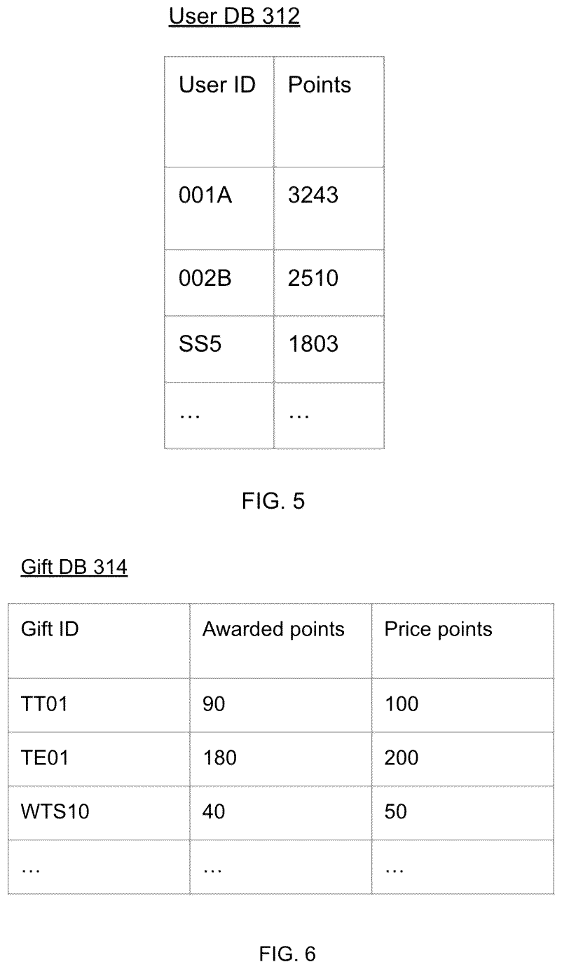

FIG. 5 is a data structure diagram showing an example of the user DB 312 of FIG. 3. The user DB 312 holds information regarding users. The user DB 312 stores the user ID and the point, in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

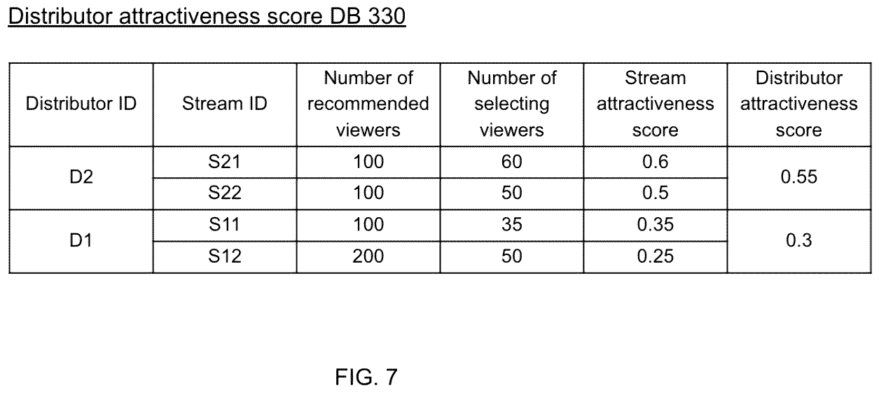

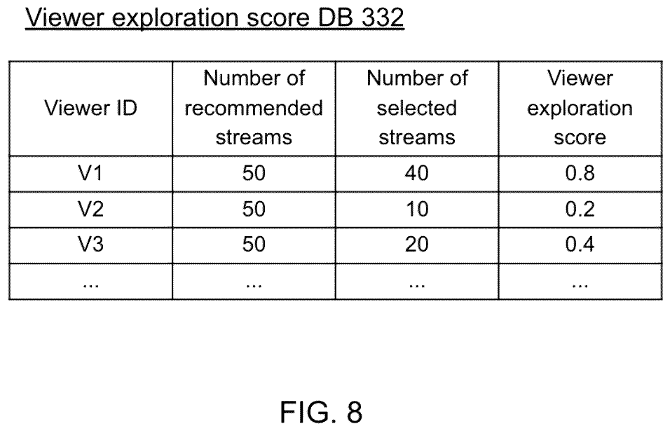

FIG. 7 is a data structure diagram showing an example of the distributor attractiveness score DB 330 of FIG. 3. The distributor attractiveness score DB 330 stores distributor ID, the stream ID, the number of recommended viewers, the number of selecting viewers, the stream attractiveness score, and the distributor attractiveness score, in association with each other.

The number of recommended viewers indicates how many viewers the corresponding stream has been recommended to (or displayed to). For example, the stream S21 has been recommended or displayed to 100 viewers. In some embodiments, the viewers could be new viewers who have not seen streams (or past streams) of the corresponding distributor before.

The number of selecting viewers indicates how many viewers, within the number of recommended viewers, have selected the corresponding stream. For example, 60 viewers out of the 100 recommended viewers selected (or clicked on, or tapped into) the stream S21.

The stream attractiveness score is a ratio of the [number of selecting viewers] to the [number of recommended viewers]. In this embodiment, the distributor attractiveness score is calculated by averaging the stream attractive scores for a distributor. There could be various calculation methods for the distributor attractiveness score. In some embodiments, the distributor attractiveness score increases as the stream attractiveness scores increase. In some embodiments, the distributor attractiveness score could be calculated based on all streams performed by the distributor within a time period. In some embodiments, the calculation of values in the distributor attractiveness score DB 330 could be performed by a calculating unit within server 10 or the determining unit 322.

A higher distributor attractiveness score indicates the distributor (or streams of the distributor, or thumbnails of the streams of the distributor) is more attractive, such that a higher percentage of viewers (or new viewers with respect to the distributor) who are recommended with streams of the distributor selected to view streams of the distributor.

FIG. 8 is a data structure diagram showing an example of the viewer exploration score DB 332 of FIG. 3. The viewer exploration score DB 332 stores the viewer ID, the number of recommended streams, the number of selected streams, and the viewer exploration score, in association with each other.

The number of recommended streams indicates how many streams have been recommended to the viewer, within a time period, for example. For example, 50 streams are recommended to viewer V1. In some embodiments, the streams could be streams of “new distributors with respect to the viewer”. That is, the streams are from distributors the viewer has not seen before.

The number of selected streams indicates how many streams, within the number of recommended streams, have been selected by the viewer. For example, viewer V1 selected and viewed 40 out of the 50 recommended streams.

The viewer exploration score is a ratio of the [number of selected streams] to the [number of recommended streams]. In some embodiments, the calculation of values in the viewer exploration score DB 332 could be performed by a calculating unit within server 10 or by the determining unit 322.

A higher viewer exploration score indicates that the viewer has more potential or tendency to explore streams (or streams from new distributors with respect to the viewer), such that a higher percentage of streams recommended (or displayed) to the viewer would be selected and viewed by the viewer.

The obtaining unit 320 is configured to obtain a request (or a spotlight request) to be recommended from a distributor. In some embodiments, the obtaining unit 320 is configured to obtain data from a database within or outside server 10, and store the data into the distributor attractiveness score DB 330, the viewer exploration score DB 332, and/or the stream position priority DB 334. The data may include the number of recommended viewers, the number of selecting viewers, the number of recommended streams, and/or the number of selected streams.

The determining unit 322 is configured to determine whether or not a distributor is eligible for making a request to be recommended. In some embodiments, a distributor needs to fulfill a certain requirement to be able to make the request to be recommended. For example, the distributor needs to acquire a predetermined amount of points or rewards within a predetermined time period, in order to make the recommendation request. The determining unit 322 may be configured to compare the reward of the distributor with the required reward threshold. That is to ensure the quality of the streams of the distributor who is eligible for making the recommendation request.

The determining unit 322 is configured to determine a parameter of a distributor to be higher or lower than a threshold. For example, the determining unit 322 determines if the distributor attractiveness score of a distributor is higher than or lower than an attractiveness score threshold. In some embodiments, if the distributor attractiveness score of a distributor is higher than the attractiveness score threshold, the distributor is referred to as a high appealing distributor. In some embodiments, if the distributor attractiveness score of a distributor is lower than the attractiveness score threshold, the distributor is referred to as a low appealing distributor. The setting of the attractiveness score threshold could be according to the actual practice or various purposes.

The determining unit 322 is configured to determine a viewer to have a parameter higher than or lower than a threshold with respect to streams recommended to the viewer. For example, the determining unit 322 determines if the viewer exploration score of a viewer is higher than or lower than an exploration score threshold, with respect to streams recommended to the viewer. In some embodiments, if the viewer exploration score of the viewer is higher than the exploration score threshold, the viewer is referred to as an active explorer. In some embodiments, if the viewer exploration score of the viewer is lower than the exploration score threshold, the viewer is referred to as an inactive explorer. The setting of the exploration score threshold could be according to the actual practice or various purposes.

The recommending unit 324 is configured to recommend a stream of a distributor to a viewer. In some embodiments, the recommending unit 324 is configured to recommend a stream of a distributor to a viewer according to [whether the distributor is high appealing or low appealing] and/or according to [whether the viewer is an active explorer or an inactive explorer]. In some embodiments, the recommending unit 324 recommends a stream of a low appealing distributor to viewers who are active explorers, such that the stream can be selected by more viewers (even though the distributor may be low appealing due to, for example, an unattractive thumbnail).

In some embodiments, the recommending unit 324 recommends a stream of a high appealing distributor to viewers who are inactive explorers. Because the distributor is highly attractive (for example, the distributor may have an attractive thumbnail), the stream can still receive a good amount of selections even from inactive explorers. Furthermore, when there is a limited number of active explorers, it is desirable to recommend streams from low appealing distributors to the active explorers to optimize the selection counts for all streams on the streaming platform. If streams from low appealing distributors are recommended to inactive explorers, the selection counts may be low.

In some embodiments, recommending a stream to a viewer indicates displaying the stream on a recommendation page on a screen of the user terminal of the viewer. In some embodiments, the distribution information providing unit 302 may be involved in the recommending process.

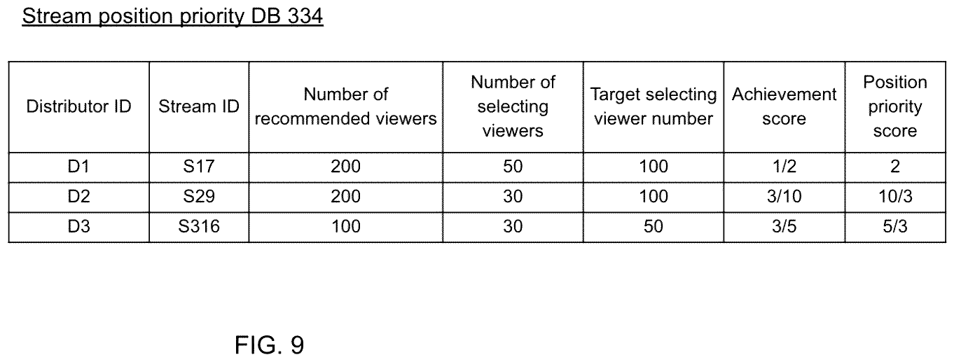

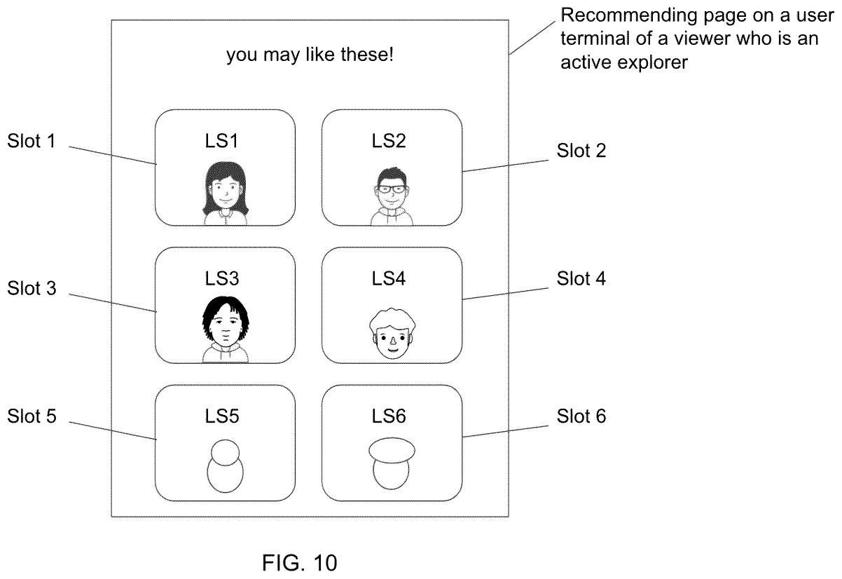

FIG. 9 is a data structure diagram showing an example of the stream position priority DB 334 of FIG. 3. The stream position priority DB 334 stores the distributor ID, the stream ID, the number of recommended viewers, the number of selecting viewers, the target selecting viewer number, the achievement score, and the position priority score, in association with each other.

The number of recommended viewers indicates how many viewers the corresponding stream has been recommended to (or displayed to). For example, the stream S17 has been recommended or displayed to 200 viewers. In some embodiments, the viewers could be new viewers who have not seen streams of the corresponding distributor before.

The number of selecting viewers indicates how many viewers, within the number of recommended viewers, have selected the corresponding stream. For example, 50 viewers out of the 200 recommended viewers selected (or clicked on, or tapped into) the stream S17.

The target selecting viewer number is the target viewer number to reach (or to be selected and viewed) for the corresponding distributor. For example, 100 is the target number of viewers who are expected to select and view a stream of distributor D1.

The achievement score indicates how close the number of selecting viewers has been to the target selecting viewer number. The achievement score is a ratio of [number of selecting viewers] to [target selecting viewer number]. A higher achievement score indicates a higher achievement rate.

The position priority score indicates the display priority (or display order) when the corresponding stream is recommended to viewers. A higher score indicates a higher display priority on a screen of the user terminal of a recommended viewer. In this embodiment, the position priority score is the reciprocal of the achievement score. In some embodiments, the position priority score decreases as the achievement score increases.

In some embodiments, when the distributor is low appealing, the corresponding recommended viewers are active explorers. In some embodiments, when the distributor is high appealing, the corresponding recommended viewers are inactive explorers.

FIG. 10 is an example of a recommending page (or spotlight recommending section) on a user terminal of a viewer.

In this embodiment, the viewer is an active explorer, therefore the streams recommended to the viewer are streams from low appealing distributors. The display order is determined according to the position priority score of each stream. For example: stream LS1 (displayed in slot 1) has a higher position priority score than stream LS2 (displayed in slot 2), which has a higher position priority score than stream LS3 (displayed in slot 3), which has a higher position priority score than stream LS4 (displayed in slot 4), which has a higher position priority score than stream LS5 (displayed in slot 5), which has a higher position priority score than stream LS6 (displayed in slot 6).

In another embodiment wherein the viewer is an inactive explorer, the streams LS1, LS2, LS3, LS4, LS5, and LS6 would be streams from high appealing distributors. The display order would also be determined according to the position priority score of each stream.

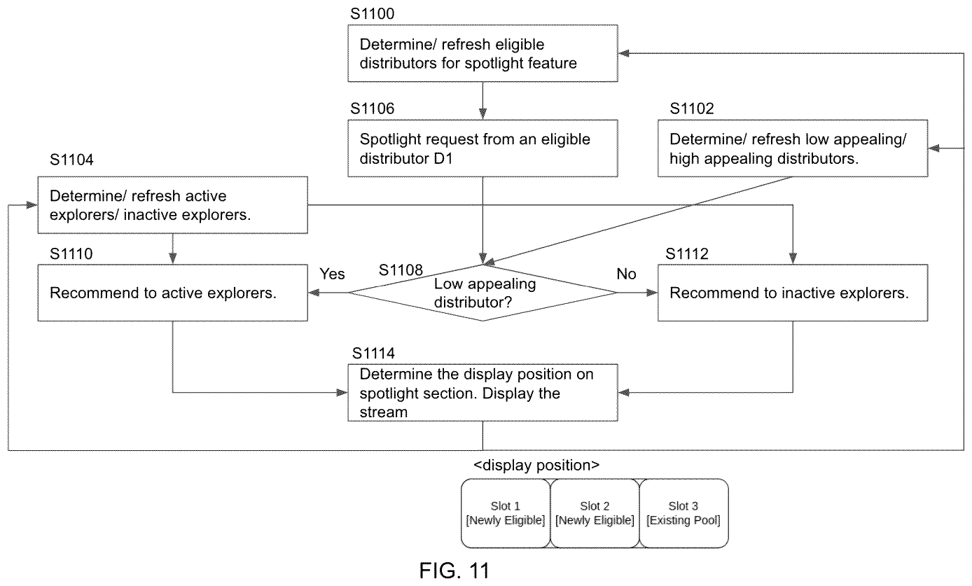

FIG. 11 shows an exemplary flowchart according to some embodiments of the present disclosure.

At step S1100, the determining unit 322 determines (or refreshes) distributors who are eligible for requesting a spotlight feature. A spotlight feature puts a stream of the distributor on a recommending page to achieve more viewers. The stream could be a live stream that is being distributed when the spotlight feature is requested by the distributor. The criterion to be an eligible distributor could be set according to various practices. In some embodiments, a distributor needs to acquire a certain amount of points to be an eligible distributor. In some embodiments, tags regarding whether or not a distributor is an eligible distributor is stored in the user DB 312.

At step S1102, low appealing and/or high appealing distributors are determined (or refreshed) according to the distributor attractiveness score DB 330, by the determining unit 322, for example. The determination result could be stored into the distributor attractiveness score DB 330 or the user DB 312, for example.

At step S1104, active explorers and/or inactive explorers are determined (or refreshed) according to the viewer exploration score DB 332, by the determining unit 322, for example. The determination result could be stored into the viewer exploration score DB 332 or the user DB 312, for example.

At step S1106, the obtaining unit 320 obtains a spotlight request from an eligible distributor D1.

At step S1108, the determining unit 322 determines whether distributor D1 is low appealing or not according to the result of step S1102. If yes, the flow goes to step S1110. If not, the flow goes to step S1112.

At step S1110, the stream is determined to be recommended to active explorers.

At step S1112, the stream is determined to be recommended to inactive explorers.

At step S1114, the display position of the stream on the recommending page is determined according to the stream position priority DB 334. The stream is displayed on the recommending page to the viewers.

The flow then goes back to step S1100, step S1102 and step S1104. The determination/refresh of the eligible distributors, the low appealing and high appealing distributors, the active and inactive explorers could be done periodically or in a real time manner.

In some embodiments, streams from newly eligible distributors are displayed with the highest priority, such as at slot 1 or slot 2 on the recommending page. In some embodiments, streams from newly eligible distributors will be recommended to all corresponding viewers (all active explorers or all inactive explorers) to increase exposure. In some embodiments, streams from other (not new) eligible distributors will be displayed in slot 3 or other subsequent slots, and the order may be determined according to the stream position priority DB 334.

In some embodiments, in the case that the distributor is low appealing and the stream is recommended to active explorers, the position to display the stream on a screen of a user terminal of one active explorer is determined according to the number of other active explorers who have selected the stream. Similarly, in the case that the distributor is high appealing and the stream is recommended to inactive explorers, the position to display the stream on a screen of a user terminal of one inactive explorer is determined according to the number of other inactive explorers who have selected the stream. Streams which have been selected by fewer viewers will be displayed with higher priorities. Streams which have been selected by more viewers will be displayed with lower priorities. That can improve the selection rates for all streams. Or, that can help all streams with the spotlight feature to achieve the target selecting viewer number.

In some embodiments, when a stream achieves the target selecting viewer number in the stream position priority DB 334 (that is, the achievement score reaches 1), the stream will be removed from the spotlight recommending section, because it has reached enough viewers with the spotlight feature. In some embodiments, the target selecting viewer number is a guaranteed number of viewers guaranteed by the spotlight feature. As long as the target selecting viewer number has not been achieved yet, the stream will be displayed in the spotlight section (or the recommending page) to reach more viewers.

In some embodiments, the number of recommended viewers and/or the target selecting viewer number are/is set to be greater when the distributor has a higher level or has gained more points in past streams. Therefore, all levels of distributors can have the motivation to achieve the criterion to be able to make the spotlight request, to further improve his/her exposure.

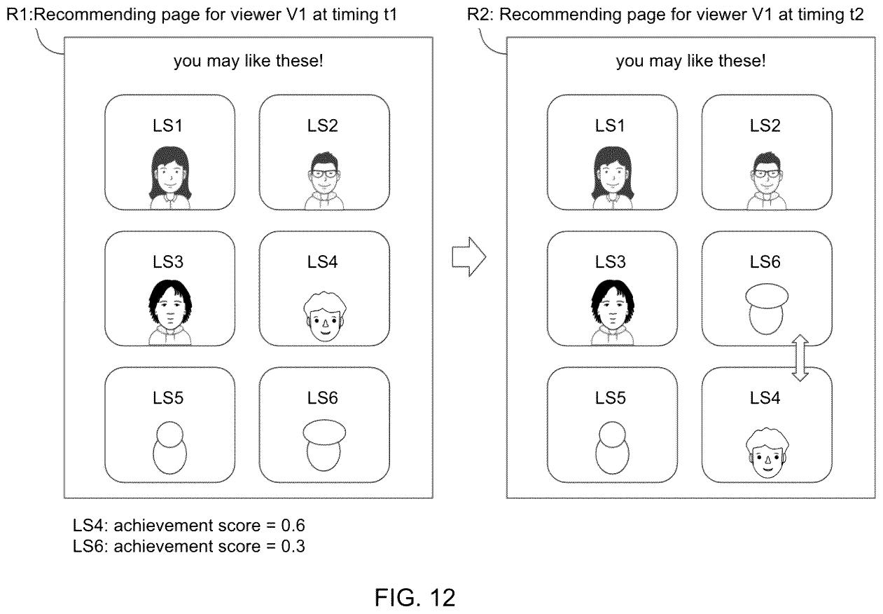

FIG. 12 shows an example of display position adjustment according to some embodiments of the present disclosure. R1 is the recommending page for viewer V1 at timing t1. R2 is the recommending page for viewer V1 at timing t2.

At timing t1, stream LS4 is displayed to viewer V1 with a higher priority than stream LS6. Stream LS4 has achieved a higher achievement score than stream LS6. Therefore, at a later timing t2, stream LS4 and stream LS6 are swapped to improve the exposure for stream LS6.

In another embodiment, R2 could be the recommending page for another viewer V2 at timing t2, and the recommending page for viewer V1 at timing t2 could be the same as timing t1. For example, streams LS1 to LS6 are streams from low appealing distributors, and therefore are recommended to active explorers including viewer V1 at timing t0 (prior to t1) by the order shown in R1. At timing t1, the calculation shows that stream LS4 has achieved a higher achievement score than stream LS6. Therefore, at timing t2 when another active explorer V2 enters the recommending page (on V2's user terminal), stream LS4 and stream LS6 are swapped in the recommending page for viewer V2 to improve the exposure for stream LS6.

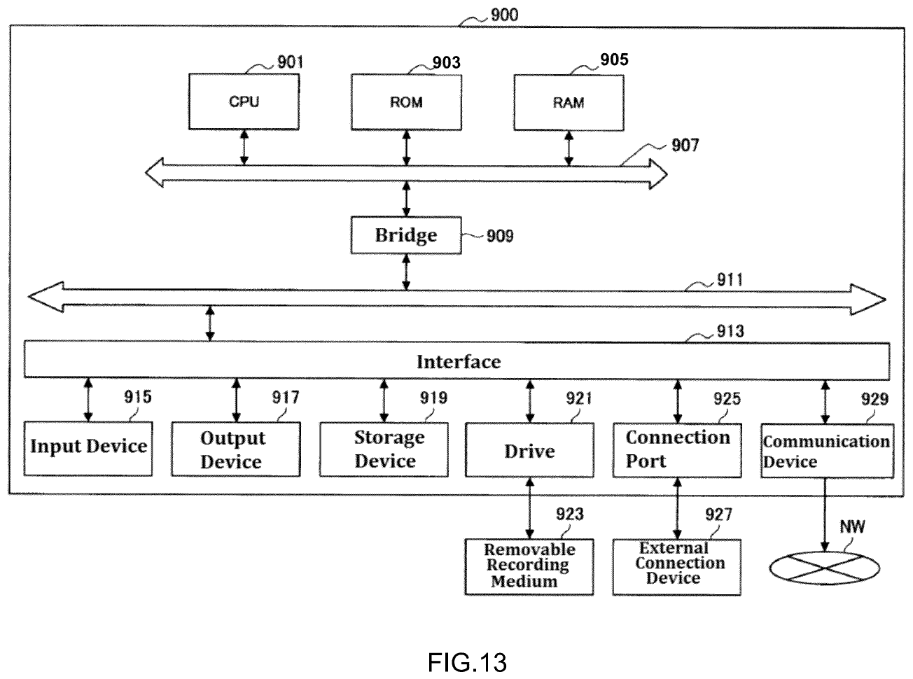

Referring to FIG. 13, the hardware configuration of the information processing device will be now described. FIG. 13 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes records in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system 1 in the embodiment have been described. This embodiment is a mere example, and it is understood by those skilled in the art that various modifications are possible for each component and a combination of each process, and that such modifications are also within the scope of the present disclosure.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

What is claimed is:

1. A method for stream recommendation, executed by a server, comprising:
determining a first parameter of a distributor to be higher or lower than a first threshold;
determining a first viewer to have a second parameter higher than a second threshold with respect to streams recommended to the first viewer;
determining a second viewer to have a second parameter lower than the second threshold with respect to streams recommended to the second viewer; and
recommending a stream of the distributor to the first viewer or the second viewer according to a result of the determining the first parameter to be higher or lower than the first threshold.

2. The method according to claim 1, further comprising:
determining the first parameter of the distributor to be lower than the first threshold; and
recommending the stream of the distributor to the first viewer.

3. The method according to claim 1, further comprising:
determining the first parameter of the distributor to be higher than the first threshold; and
recommending the stream of the distributor to the second viewer.

4. The method according to claim 1, further comprising:
determining the first parameter of the distributor according to a number of viewers who have been recommended with streams of the distributor and a number of viewers who selected the streams of the distributor.

5. The method according to claim 1, further comprising:
determining the second parameter of the first viewer according to a number of streams recommended to the first viewer and a number of streams selected by the first viewer.

6. The method according to claim 1, further comprising:
determining the distributor to be eligible for making a request to be recommended; and
obtaining the request from the distributor.

7. The method according to claim 2, further comprising:
determining a first set of viewers to have second parameters higher than the second threshold with respect to streams recommended to the first set of viewers;
recommending the stream of the distributor to the first set of viewers;
determining a position to display the stream of the distributor on a screen of a user terminal of the first viewer according to a number of viewers within the first set of viewers who have selected the stream of the distributor.

8. The method according to claim 7, wherein a priority of the position to display the stream on the screen of the user terminal of the first viewer decreases as the number of viewers within the first set of viewers who have selected the stream increases.

9. A system for stream distribution, comprising one or a plurality of processors, wherein the one or plurality of processors execute a machine-readable instruction to perform:
determining a first parameter of a distributor to be higher or lower than a first threshold;
determining a first viewer to have a second parameter higher than a second threshold with respect to streams recommended to the first viewer;
determining a second viewer to have a second parameter lower than the second threshold with respect to streams recommended to the second viewer; and
recommending a stream of the distributor to the first viewer or the second viewer according to a result of the determining the first parameter to be higher or lower than the first threshold.

10. A non-transitory computer-readable medium including a program for stream distribution, wherein the program causes one or a plurality of computers to execute:
determining a first parameter of a distributor to be higher or lower than a first threshold;
determining a first viewer to have a second parameter higher than a second threshold with respect to streams recommended to the first viewer;
determining a second viewer to have a second parameter lower than the second threshold with respect to streams recommended to the second viewer; and
recommending a stream of the distributor to the first viewer or the second viewer according to a result of the determining the first parameter to be higher or lower than the first threshold.
